(19) United States
(12) Patent Application Publication
(10) Pub. No.: US 2015/0053115 A1
(43) Pub. Date: Feb. 26, 2015

(54) METHOD FOR RECYCLING POWDERED PAINT WASTE AND PRODUCTS RESULTING FROM SAID METHOD

(71) Applicant: René Anglade, Meru (FR)

(72) Inventor: René Anglade, Meru (FR)

(21) Appl. No.: 14/381,648

(22) PCT Filed: Feb. 28, 2013
(86) PCT No.: PCT/FR2013/050423

§ 371 Date: Aug. 28, 2014

(30) Foreign Application Priority Data
Mar. 1, 2012 (FR) 1200614

(51) Int. Cl. C04B 26/00; B29C 67/24

(52) U.S. Cl. CPC C04B 26/006; B29C 67/24; B29K 2105/251
USPC 106/287.34; 264/122; 264/112

(57) ABSTRACT

A method for recycling powdered paint waste and products resulting from the method. The powdered paint waste is mixed with reclaimed sand. The mixture is arranged in a mold and heated in a furnace. The resulting product is released from the mold after cooling. The resulting product constitutes a finished or semi-finished product. Inserts can be arranged in the mixture as needed.

The invention relates to a method for recycling powdered paint waste and the products obtained by said method.

It is known that coating techniques employing powdered paint are extremely wasteful, about 40% of the powder used being lost. Specifically, one known technique consists in spraying, in a spray booth, the powdered paint onto a metal object to be coated, said object generally being scoured by sandblasting beforehand, whereas the powder is temporarily fastened to the object via an electrostatic effect, then polymerized by heating. A large amount of the powder is not deposited on the object and thus forms a source of waste, said waste powder generally being evacuated from the spray booth by suction. The amount of unused powder thus reclaimed represents a very substantial percentage of the initial amount of powder.

This waste powder, which is toxic, is subject to environmental regulations that oblige manufacturers to pay for said waste to be collected. The waste is for example incinerated or used as an admixture in cement making. The incineration of these products has the notable drawback of producing a certain amount of CO₂, especially in light of the fact that about 400,000 tonnes of these products are produced per year in certain countries such as France.

It is known to recycle powdered paint waste from document KR 2001 0084427. However, this recycling is carried out by mixing the paint waste with a high proportion, greater than half of the waste mixture, of vinyl. The product thus obtained is not directly usable.

The object of the present invention is therefore to mitigate one or more of the drawbacks of the prior art by providing a method for recycling powdered paint waste, consisting in mixing said waste with reclaimed sand, in placing said mixture in a mold and in heating the mixture and mold together in an oven, then in demolding the product obtained after it has cooled, said product forming a finished or semifinished product.

According to one embodiment of the invention, the amount of sand used is larger than that of the powdered paint.

According to one embodiment of the invention, the heating of the mixture is carried out at about 200° C.

Baking at 200° C. stops CO₂ from being produced.

According to one embodiment of the invention, the method consists in using a mold equipped with a nonstick coating.

According to one embodiment of the invention, the method consists in using reclaimed sand originating from sandblasting scouring operations.

Specifically, the sand used especially in sandblasting operations constitutes in its entirety products that are difficult to recycle due to the fact that it is contaminated after use.

According to one embodiment of the invention, the method consists in adding at least one additive to the mixture.

According to one embodiment of the invention, the method consists in placing one or more inserts in the mixture before it is heated.

According to one embodiment of the invention, the insert is an oblong object.

According to one embodiment of the invention, the insert is a grating.

According to one embodiment of the invention, the insert is a perforated sheet.

According to one embodiment of the invention, the method consists in polishing and/or painting the material thus obtained.

The invention also relates to the product obtained by the method according to the invention.

The invention also relates to the use of the product according to the invention in the construction industry and/or in public works.

The invention also relates to the use of the product according to the invention to manufacture decorative elements.

Of course, the invention also relates to any product or material manufactured by implementing the aforementioned method, said product possibly being intended for many different applications because of the properties of the components of the mixtures and the various possible shapes of the molds and optional inserts. The invention may especially and more specifically relate to the construction industry and/or public works or even be intended for manufacturing decorative elements.

The invention will be clearly understood on reading the following description that refers to the appended drawings in which figures one to four schematically show, by way of nonlimiting examples, cross-sectional perspective views of four molds before or after a mixture according to the invention equipped with inserts has been oven baked.

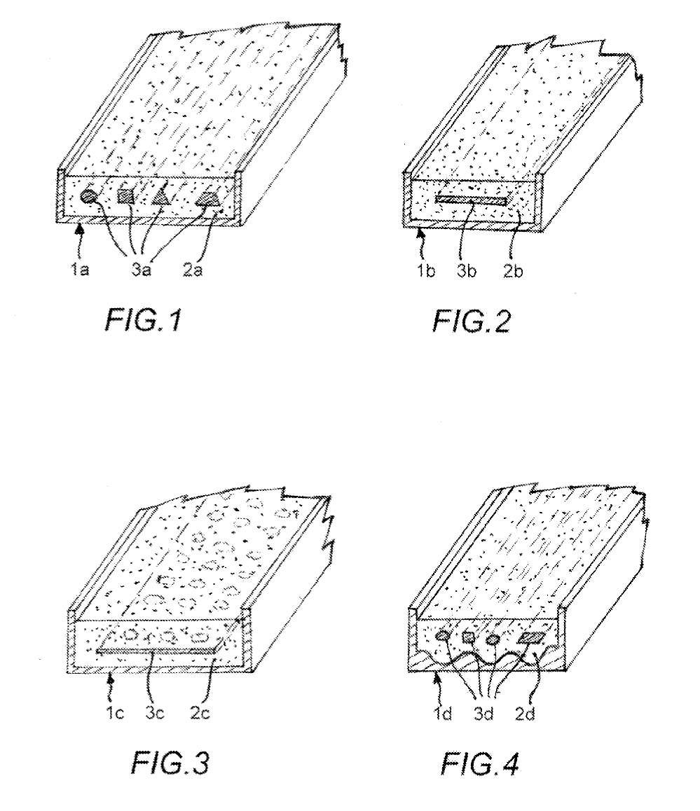

FIGS. 1 to 4 show four molds 1a, 1b, 1c and 1d. Here it is a question of open molds but they could of course be closed. The material of the molds may furthermore be flexible or rigid.

The method according to the present invention consists in filling each of the molds with a mixture of powdered paint waste and sand, this mixture being represented by dots labeled 2a to 2d. The powdered paint waste/sand proportions depend on the final use of the product manufactured according to this method.

According to one embodiment of the invention, the amount of sand used is larger than that of the powdered paint waste.

According to another embodiment of the invention, the amount of powdered paint waste is larger than that of the sand, although the latter is present in a proportionally non-negligible amount.

Even though because of the nature of the powdered paint, generally an epoxy, polymer or similar, etc., the aforementioned mixture is thermosetting in nature, the product thus obtained is surprisingly hard and strong especially allowing water jet cutting, tapping and drilling to be achieved.

According to one embodiment of the invention, depending on the final application, any sort of additional products or materials, such as stone chippings, sawdust, paper waste, chemicals, etc., may be added to the mixture of sand and paint.

According to one embodiment of the invention, oblong inserts 3a and 3d of various cross sections are placed in the mixture in the molds 1a and 1d. By way of example, a plate 3b has been placed in the mold 1b and a perforated sheet 1c has been placed in the mold 1c. It may of course be a question of any other type of insert such as a grating or otherwise, said inserts furthermore being solid or hollow, their utility being specified below.

The material used for the inserts may also be of any nature and they are especially made of metal but also of wood, plastic, cardboard or rubber, etc.

The molds 1a-1c are for example covered internally with a nonstick coating in order to facilitate demolding.

The shape of the mold is tailored to the final destination of the product obtained, as explained below and as shown in FIG. 4. It is possible for example to provide a mold with a corrugated bottom.

In the method according to the invention, the molds, containing the powdered paint waste/sand mixture, are heated at a temperature comprised between 180 and 210° C. and preferably equal to 200° C.

According to another embodiment of the invention, a temperature above or below 200° C. is used.

One of the advantages of such a bake, relative to the incineration used in the prior art, is that it does not produce CO₂.

According to one embodiment of the invention, the products obtained after cooling and demolding have the shapes shown in the drawings which may be used in many different industries with a view for example to forming construction materials for the manufacture of interior or exterior architectural claddings.

Decorative elements, slabs and borders for gardens or even tiles may also be manufactured in this way, or the product obtained may be used in road building, many more other applications also being envisionable.

The optional inserts serve to increase strength and make it possible to join a number of products together, for example with bolts or otherwise.

Each product obtained may furthermore undergo subsequent treatment, for example being polished and/or painted.

The product obtained according to the invention has proved to possess advantageous properties in terms of strength but also in terms of ease of cutting, stability, etc.

1-14. (canceled)

15. A method for recycling powdered paint waste, comprising the steps of mixing the powered paint waste with reclaimed sand to provide a mixture; arranging the mixture in a mold; heating the mixture and mold together in an oven to provide a product; and de-molding the product obtained after the mold is cooled, the product forming a finished or semi-finished product.

16. The method as claimed in claim 15, wherein an amount of the reclaimed sand used is larger than that of the powdered paint waste.

17. The method as claimed in claim 15, further comprising the step of heating the mixture substantially at 200° C.

18. The method as claimed in claim 15, further comprising the step of arranging the mixture in the mold equipped with a nonstick coating.

19. The method as claimed in claim 15, further comprising the step of mixing the powered paint waste with the reclaimed sand originating from sandblasting scouring operations.

20. The method as claimed in claim 15, further comprising the step of adding at least one additive to the mixture.

21. The method as claimed in claim 15, further comprising the step of arranging one or more inserts in the mixture before the mixture is heated.

22. The method as claimed in claim 21, wherein the insert is an oblong object.

23. The method as claimed in claim 21, wherein the insert is a grating.

24. The method as claimed in claim 21, wherein the insert is a perforated sheet.

25. The method as claimed in claim 15, further comprising the step of polishing the product.

26. The method as claimed in claim 25, further comprising the step of painting the product.

27. The method as claimed in claim 15, further comprising the step of painting the product.

28. A product obtained using a method for recycling powdered paint waste, comprising the steps of mixing the powered paint waste with reclaimed sand to provide a mixture; arranging the mixture in a mold; heating the mixture and mold together in an oven to provide a product; and de-molding the product obtained after the mold is cooled, the product forming a finished or semi-finished product.

30. The use of the product as claimed in claim 28 in at least one of the following:
construction industry and public works.

31. The use of the product as claimed in claim 28 to manufacture decorative elements.
